(19) United States
(12) Patent Application Publication
(10) Pub. No.: US 2003/0156436 A1
(43) Pub. Date: Aug. 21, 2003

(54) Starting and power -voltage-drop protection circuit for a contactless circuit

(76) Inventors: Christophe Moreaux, Eyvilles (FR); Ahmed Kari, Aix En Provence (FR); Olivier Tardiue, Marseille (FR)

Correspondence Address: Andre M. Szuwalski, Jenkens & Gilchrist, P.C., Suite 3200, 1445 Ross Ave., Dallas, TX, 75202-2799, US

(21) Appl. No.: 10/350,790

(22) Filed: Jan. 24, 2003

(30) Foreign Application Priority Data
Jan. 31, 2002 (FR) 02 01124

(51) Int. Cl. H02M 1/00

(52) U.S. Cl. 363/49

(57) ABSTRACT

A contactless integrated circuit includes a voltage generator (11, 12, 13) to produce a power supply voltage (VDD) from a received RF signal. A starting circuit for the contactless integrated circuit produces a disabling signal (POR) until the power supply voltage (VDD) reaches a first voltage threshold (VS1) The starting circuit further produces the disabling signal (POR) when the power voltage (VDD) falls below a second voltage threshold (VS2) that is lower than the first voltage threshold (VS). The starting circuit has application for use in connection with chip cards, transponders, and the like.

### CROSS REFERENCE

The present application for patent claims foreign priority from French Patent Application No. 0201124 filed Jan. 31, 2002, the disclosure of which is hereby incorporated by reference.

### BACKGROUND OF THE INVENTION

1. Technical Field of the Invention

The present invention relates to a starting and power-voltage-drop protection circuit for a contactless integrated circuit (or chip), a smart card, a transponder, and the like.

2. Description of Related Art

In a contactless circuit, the data and power received by the contactless circuit (or chip) are transmitted by a reader (or transmitter) in the form of an amplitude-modulated RF signal. The term “modulation” is often used when referring to communication from the reader to the chip. Additionally, the chip may send digital data to the reader. In this case, the term used is “back modulation.”

A prior art contactless circuit comprises, for example as shown in FIG. 1, an antenna 11, a rectifier bridge 12, a voltage regulator 13 and a starting circuit 14.

The RF signal is received by the antenna 11 which produces two signals AC0 and AC1 having the shape of two positive half-waves, the RF signal being approximately equal to the result of the subtraction of the signal AC1 from the signal AC0.

The rectifier bridge 12 is a conventionally known four-diode bridge. It has two inputs connected to two inputs-outputs of the antenna 11 to receive the two signals AC0 and AC1, and one output at which a rectified voltage HVR is produced. The voltage HVR is approximately the sum of the two signals AC0 and AC1. The mean amplitude of the rectified voltage HVR varies especially as a function of the distance between the reader and the chip, and thus can thus vary from approximately 2 V when the chip is at a distance of some tens of cm from the reader to about 15-20 V when the chip is at a distance of some millimeters from the reader. In practice, the voltage HVR is most usually limited to about 8 V by an appropriate device.

The voltage regulator 13 receives the rectified voltage HVR and produces the power supply voltage VDD having a nominal value VDD0 (for example of about 3 V for 0.6 μm technology). VDD will be used for the power supply of all the specialized circuits of the chip (not shown in FIG. 1, but likely to include modulation and demodulation circuit for data processing, memory, logic circuits, and the like). The regulator 13 comprises, inter alia, a filter comprising especially a set of resistors and capacitors associated according to known schemes.

The voltage VDD varies in the manner illustrated in FIG. 2. At the beginning of the reception of the RF signal transmitted by the reader, during a transient phase, the voltage varies at fairly high speed between a zero value and a nominal value VDD0 (in the example 3 V). The voltage VDD is then maintained at its nominal value VDD0 to the greatest possible extent. The voltage VDD finally drops to zero when the reception of the RF signal is interrupted.

In the prior art, the starting circuit 14 receives the voltage VDD and produces a control signal POR. POR is active if the voltage VDD is below a voltage threshold VS.

The signal POR thus blocks the operation of the specialized circuits of the chip when the circuit is started and causes these circuits to be reset when the voltage VDD reaches a value sufficient to provide for their efficient operation. As the case may be, the signal POR is reactivated if the voltage VDD drops below the threshold VS. The regulator 13 for its part remains, of course, always in operation.

Each activation of the signal POR gives rise to a break in communications between the chip and the reader. Any new communication starts with a particularly lengthy step for resetting the chip.

The voltage threshold VS is the minimum value of VDD needed to perform all the functions of the chip in a perfectly reliable way. In practice, the threshold VS is fairly high. This is an indispensable condition for reliable performance, especially with respect to the operations for programming the memory of the chip. For example, the threshold voltage VS is chosen so as to be in the range of 85% of VDD0, namely about 2.5 V for a voltage VDD0 in the range of 3 V.

The maximum operating distance of the chip is the maximum distance beyond which communication between the reader and the chip is no longer possible. In other words, the maximum distance is the distance beyond which the voltage VDD remains below the threshold VS. The higher the threshold VS, the smaller is the maximum distance.

In contactless applications, the voltage VDD often varies to a greater or lesser degree, even after the starting phase.

The voltage VDD varies as a function of the distance between the reader and the chip. Indeed, if the distance between the reader and the chip is greater than the maximum working distance, the voltage VDD varies as a function of the distance between the reader and the chip but remains below VS. If the distance between the reader and the chip is slightly smaller than the maximum distance, then the voltage VDD varies as a function of the distance between the chip and the reader and is greater than VS. Finally, if the chip is very close to the reader, the voltage VDD is constant, equal to its nominal value VDD0.

The power voltage also varies as a function of the activity of the specialized circuits of the chip. For example, in back modulation (communication from the chip to the reader) the RF signal of the data to be returned by the chip to the reader is modulated by modulating the charge perceived by the antenna 11. This leads to a substantial and immediate drop in the amplitude of the signals AC0, AC1 as soon as the back modulation starts. The reduction of the amplitude of the signal AC0 will lead to a corresponding reduction of the voltage VDD. The maximum distance of operation of the chip in back modulation is thus smaller than the maximum distance of operation in modulation (communication from the reader to the board).

It is seen, in practice, that the maximum distance of operation of the chip is very short, especially in back modulation. The risk of going beyond this distance is therefore great. It may be recalled that going beyond the maximum distance of operation leads to a major risk of error of communication between the reader and the chip (a risk of a break in a communication, a programming error, and the like) and/or a major risk of resetting of the chip. This obviously limits the value of contactless circuits.

There is a need for a circuit that reduces the risk of failure of a communication in progress between the reader and the chip, without adversely affecting its reliability.

There is also a need for a circuit that increase the maximum distance of operation between the reader and the chip.

### SUMMARY OF THE INVENTION

To address the foregoing and other needs, the present invention proposes a starting circuit in a contactless integrated circuit comprising a voltage generator to produce a power supply voltage VDD as a function of a received RF signal. The starting circuit further produces a disabling signal when the power supply voltage has not reached a first voltage threshold.

According to the invention, the starting circuit also produces the disabling signal when the power voltage falls below a second voltage threshold below the first voltage threshold.

In other words, with a starting circuit according to the present invention, no communication can be set up between the reader and the chip so long as the power voltage has not reached the first threshold. Furthermore, a communication link is not interrupted so long as the power supply voltage has not fallen below the second threshold.

The most sensitive operations, which must imperatively be reliable, are carried out in practice during the phase of resetting the chip. These are, for example, operations for programming the memory or operations for defining access rights.

Consequently, it is preferred to choose a first threshold VS1 that is high enough to ensure the integrity of the operations performed during the resetting phase. For this purpose, for example, a first threshold is chosen such that it is at least equal to the threshold commonly chosen in known equivalent circuits. For example, the threshold chosen is a threshold VS1 of about 2.5 V for a nominal voltage VDD0 of about 3 V.

However, the operations performed subsequently, after the resetting step, are generally less sensitive: a failure of these operations generally has no serious consequences. Hence, preferably a second threshold voltage VS2 is chosen at a level lower than the first threshold VS1. For example, the threshold is chosen to be close to the electrical operating limit of the specialized circuits of the chip, so as to increase the maximum operating distance as much as possible, at least during communication. For example, it is possible to choose a second threshold VS2 of about 2 V for a nominal voltage of 3 V.

According to one mode of implementation, the starting circuit of the invention comprises:

a voltage divider bridge to give a voltage that is the image of the power supply voltage, and

a comparator, to compare the image voltage with a first image threshold if the image voltage increases from a value below a second image threshold, and to compare the image voltage with the second image threshold if the voltage decreases from a value greater than the first image threshold, the comparator giving the disabling signal that results from the comparison.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1, which has already been described, is a functional drawing of a prior art contactless circuit;

FIG. 2 is a timing diagram showing the progress in time of the power supply voltage produced by the circuit of FIG. 1;

FIG. 3 is a timing diagram showing the progress in time of the disabling signals produced by a starting circuit according to the present invention; and

FIG. 4 is a drawing of an exemplary implementation of a starting circuit according to the invention.

### DETAILED DESCRIPTION OF THE DRAWINGS

An exemplary embodiment of the invention is shown in FIG. 4. The circuit has two resistors R1, R2 and one comparator TS.

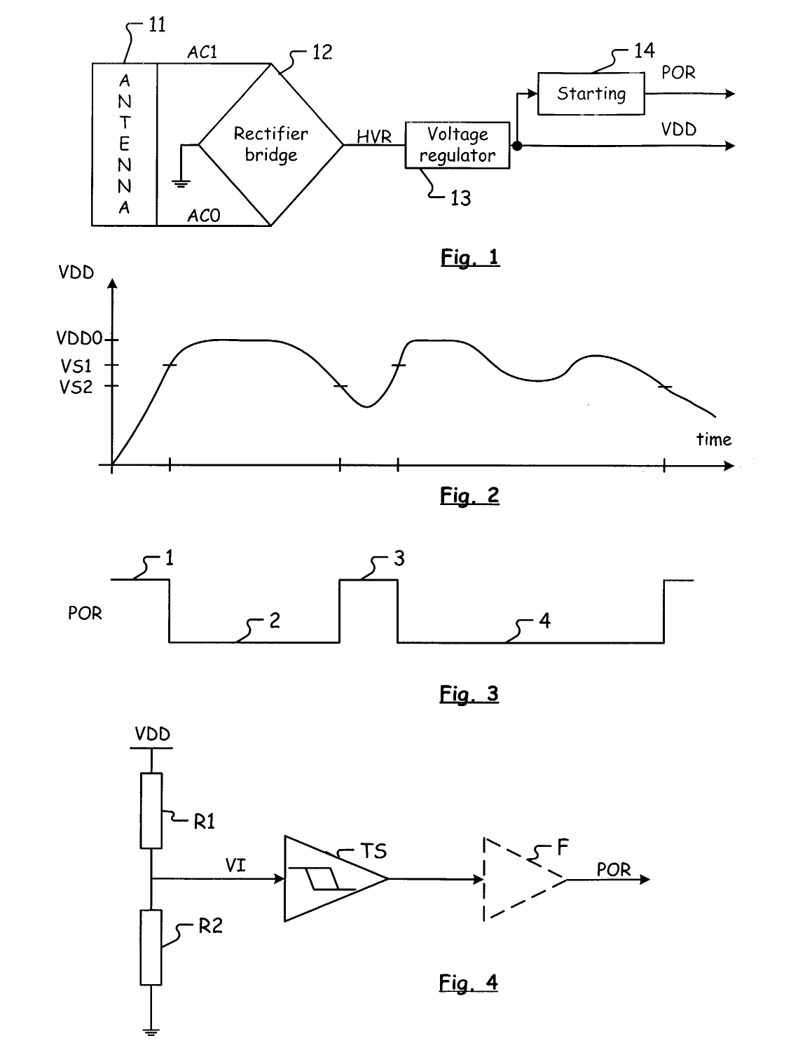

The two resistors R1, R2 are series-connected between a voltage generator (not shown), giving the supply voltage VDD to be monitored, and a ground of the circuit. In one example, the voltage generator may be constituted by circuits 11, 12, 13 of the drawing of FIG. 1.

The two resistors R1, R2 form a voltage divider bridge comprising an input to which the voltage VDD is applied and an output at which a voltage VI is produced. This voltage VI is the image of the voltage VDD but has a smaller amplitude. In practice, the voltage VI is equal here to R2/(R1+R2). In one numerical example, R1 may be chosen to be in the range of R2 so that the voltage VI is in the range of VDD/2. The resistors R1, R2 preferably have a high value, so as to limit the current that they consume.

The comparator TS has an input to which the voltage VI is applied and an output at which the disabling signal POR is produced.

The comparator TS is a comparator with two thresholds VST1 and VST2. It is, for example, a comparator of the Schmitt trigger type. The comparator gives a signal POR (FIG. 3) which is:

active when the voltage VI varies and is below the threshold VST1 (references 1 and 4 in FIG. 3), after having been below the threshold VST2; and

inactive when the voltage VI varies and remains above VST2 (reference 2 in FIG. 3), after having been above the first threshold VST1.

It is also possible to speak of the upward threshold for VST1, used especially when starting a communication link between the reader and the chip. Similarly, it is possible to speak of the downward threshold for VST2, used especially in the case of a voltage drop (which may occur when, for example, the distance between the chip and the reader increases, or a back modulation starts).

It will be noted that, in FIG. 3, the signal POR has been shown as a logic signal, active at 1 and inactive at 0. In reality, the signal POR follows the variations of VDD when it is active and remains equal to 0 when it is inactive.

It will also be noted that it is not generally possible to directly study the variations in the voltage VDD. The use of the voltage divider bridge (R1 and R2) is therefore indispensable in the example of FIG. 4.

Indeed, the comparator TS is made according to a known scheme comprising especially a set of logic gates and transistors. The transistors are necessarily powered by the voltage VDD which, in practice, powers all the specialized circuits of the chip, including the starting circuit of the invention. The threshold voltage of the transistors is about 0.9 V. The thresholds VST1, VST2 which can be chosen for the comparator are then necessarily included between VSS+0.9 V and VDD−0.9 V, VSS being a ground of the circuit.

The thresholds VST1 and VST2 of the comparator are chosen as a function of the thresholds VS1 and VS2 to be detected on the supply voltage VDD, and the reduction coefficient imposed by the voltage divider bridge:

VST1=VS1*R2/(R1+R2)

VST2=VS2*R2/(R1+R2).

In one digital example, if we choose R1=R2, VDD0=3 V, VS1=2.5 V and VS2=2 V, then VI=VDD/2, VST1=1.25 V and VST2=1 V.

It must be noted that these values are only approximate ones: indeed, in practice, the thresholds VST1, VST2 of the comparator vary slightly as a function of the power supply voltage of the comparator, namely as a function of the voltage VDD which is monitored by the comparator.

According to one variant of the divider bridge of FIG. 4, a transistor (not shown in FIG. 4) is added. A drain and a source of which are connected between the resistor R1 and the source supplying the power voltage VDD, and a gate of which is connected to the power voltage VDD. Thus, the voltage applied between the resistors R1 and R2 is reduced. This reduces the size of the resistors, while the consumption of the assembly remains identical.

According to another variant, the resistors R1 and R2 are replaced by any other type of voltage divider capable of giving a voltage that is the image of the power supply voltage. This image voltage has a lower amplitude. For example, this divider may comprise a capacitive bridge.

According to another variant, a filter F (shown in dashes in FIG. 4) is added to the output of the comparator TS, to filter the signal produced by the comparator and thus produce a filtered signal POR. This activates the signal POR when a glitch appears at the signal produced by the comparator.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A starting circuit in a contactless integrated circuit comprising a voltage generator to produce a power supply voltage from a received RF signal, the starting circuit producing a disabling signal when the power supply voltage has not reached a first voltage threshold (VS1), wherein the starting circuit also produces the disabling signal (POR) when the power voltage falls below a second voltage threshold that is lower than the first voltage threshold.

2. The circuit according to claim 1, comprising:
a voltage divider bridge to give a voltage that is the image of the power supply voltage; and
a comparator that compares the image voltage with a first image threshold voltage if the image voltage increases from a value below a second image threshold voltage, and to compare the image voltage with the second image threshold voltage if the voltage decreases from a value greater than the first image threshold voltage, the comparator giving the disabling signal that results from the comparison.

3. The circuit according to claim 2, wherein the voltage divider bridge comprises two series-connected resistors, the power supply voltage being applied to a terminal of one of the resistors, a reference voltage being applied to a terminal of the other of the resistors and the image voltage being produced at the common point of the two resistors.

4. The circuit according to claim 2, wherein the voltage divider bridge comprises two resistors and one transistor that are series-connected, the power supply voltage being applied to a gate and a drain of the transistor, a source of which is connected to a terminal of one of the resistors, a reference voltage being applied to a terminal of the other of the resistors and the image voltage being produced at the common point of the two resistors.

5. The circuit according to claim 2, also comprising a filter (F) to receive and filter the disabling signal.

6. A method for generating an enable/disable control signal for a contactless integrated circuit comprising the steps of:
monitoring a supply voltage derived from a received RF signal;
first changing the enable/disable signal from a first state to a second state when the monitored supply voltage rises above a first threshold value; and
second changing the enable/disable signal from the second state to the first state when the monitored supply voltage drops below a second threshold value;
wherein the first threshold value exceeds the second threshold value.

7. The method of claim 6 wherein the step of monitoring comprises the step of producing an image voltage from the supply voltage.

8. The method of claim 7 wherein the step of first changing comprises the step of changing signal state when the image voltage rises above a first image threshold value, and wherein the step of second changing comprises the step of changing signal state when the image voltage drops below a second image threshold value.

9. A contactless integrated circuit, comprising:
a voltage generator that produces a power supply voltage from a received RF signal; and
a starting circuit that generates an enable/disable control signal responsive to changes in the power supply voltage such that the enable/disable control signal changes from a first state to a second state when the power supply voltage rises above a first threshold value, and changes from the second state to the first state when the monitored supply voltage drops below a second threshold value that is less than the first threshold value.

10. The circuit of claim 9 wherein the starting circuit includes a voltage divider to generate an image voltage.

11. The circuit of claim 10 wherein the voltage divider is a resistive voltage divider.

12. The circuit of claim 11 wherein the resistive voltage divider includes a series connected transistor.

13. The circuit of claim 10 wherein the starting circuit further comprises a comparator operable to compare the image voltage against a first and second image thresholds which are related to the first and second threshold voltages.

14. The circuit of claim 13 wherein the starting circuit further comprises a filter connected to an output of the comparator to generate the enable/disable control signal.
